(19) United States
(12) Patent Application Publication
(10) Pub. No.: US 2026/0025441 A1
(43) Pub. Date: Jan. 22, 2026

(54) Methods for Delivering DOCSIS Configuration and Firmware Via a TFTP to HTTPS Proxy and Cache Service

(71) Applicant: Charter Communications Operating, LLC, St. Louis, MO (US)

(72) Inventors: Joshua E. NELSON, Aurora, CO (US); Ajay G. SRIRAM, Parker, CO (US); Dustin B. PHILLIPS, Denver, CO (US); Vigan SALIHU, Denver, CO (US)

(21) Appl. No.: 18/775,134

(22) Filed: Jul. 17, 2024

(51) Int. Cl. H04L 67/5681; H04L 67/00; H04L 67/06

(52) U.S. Cl. CPC H04L 67/5681; H04L 67/06; H04L 67/34

(57) ABSTRACT

Systems, methods, and devices for delivering configuration files and firmware updates to Customer Premises Equipment (CPE) using a Trivial File Transfer Protocol (TFTP) to Hypertext Transfer Protocol Secure (HTTPS) proxy service are disclosed. Embodiment methods may include the TFTP-to-HTTPS proxy service listening on a User Datagram Protocol (UDP) port for incoming TFTP requests, receiving a TFTP request from a CPE device, translating the TFTP request into an HTTPS request, sending the translated HTTPS request to a backend server, receiving an HTTPS response, translating the HTTPS response into a TFTP response, and sending the TFTP data packets to the CPE device. Some embodiments may include storing the translated file in the cache, checking the cache for a requested file before requesting the file from the backend server, and sending the cached file to the requesting CPE device when it is stored in the cache.

### BACKGROUND

The deployment and management of network services face numerous technical challenges in modern networking environments. One significant challenge involves the delivery of data over cable service interface specification (DOCSIS) configuration files and customer premises equipment (CPE) firmware using the trivial file transfer protocol (TFTP). This legacy protocol presents several technical challenges, including potentially suboptimal throughput and latency, complicated operations due to random port utilization, and limited security features. These technical challenges and complications may result in prolonged firmware delivery times and increased mean time to recovery (MTTR) during troubleshooting.

Contemporary protocols, such as HyperText Transfer Protocol/HyperText Transfer Protocol Secure (HTTP/HTTPS), offer improved performance and security features. However, transitioning existing CPE devices to support these protocols remains challenging. Modern applications predominantly utilize HTTP, so it is desirable to evolve from TFTP to a more secure and efficient protocol without altering the behavior of CPE devices governed by DOCSIS specifications.

### SUMMARY

Various aspects include methods for delivering configuration files and firmware updates to a Customer Premises Equipment (CPE) device from a Hypertext Transfer Protocol Secure (HTTPS) service on a backend server. Various aspects may include receiving a Trivial File Transfer Protocol (TFTP) request from the CPE device in a TFTP-to-HTTPS proxy service in which the TFTP request includes a request for a configuration file or a firmware update, translating the TFTP request into an HTTPS request in the TFTP-to-HTTPS proxy service, sending the HTTPS request from the TFTP-to-HTTPS proxy service to the backend server, receiving in the TFTP-to-HTTPS proxy service from the backend server an HTTPS response that includes the requested configuration file or firmware update, translating the HTTPS response into a TFTP response TFTP-to-HTTPS proxy service, and sending TFTP data packets from the TFTP-to-HTTPS proxy service to the CPE device.

Some aspects may further include segmenting the HTTPS response into TFTP data packets and establishing a TFTP data transfer session with the CPE device before sending the TFTP data packets from the TFTP-to-HTTPS proxy service to the CPE device.

In some aspects, receiving the TFTP request from the CPE device may include receiving the TFTP request on a User Datagram Protocol (UDP) port of the TFTP-to-HTTPS proxy service.

Some aspects may further include checking a cache in the TFTP-to-HTTPS proxy service for the requested configuration file or firmware update, determining whether the requested configuration file or firmware update is present in the cache of the TFTP-to-HTTPS proxy service. In such aspects, in response to determining that the requested configuration file or firmware update is not present in the cache of the TFTP-to-HTTPS proxy service the TFTP-to-HTTPS proxy service performs operations including sending the HTTPS request to the backend server, receiving the HTTPS response from the backend server, translating the HTTPS response into a TFTP response, and sending the translated TFTP response to the CPE device, and the method further may include storing the translated HTTPS response in the cache of the TFTP-to-HTTPS proxy service. In such aspects, in response to determining that the requested configuration file or firmware update is present in the cache of the TFTP-to-HTTPS proxy service, methods may further include sending the stored translated HTTPS response from the cache of the TFTP-to-HTTPS proxy service to the CPE device.

Some aspects may further include the TFTP-to-HTTPS proxy service receiving acknowledgments from the CPE device for each of the TFTP data packets, and terminating the TFTP data transfer session upon successful transmission of all TFTP data packets to the CPE device.

Some aspects may further include loading configuration settings into the TFTP-to-HTTPS proxy service, the configuration settings comprising one or more of backend server universal resource locators (URLs), caching settings, or authentication schemas. Some aspects may further include the TFTP-to-HTTPS proxy service periodically checking for configuration updates for the TFTP-to-HTTPS proxy service, retrieving updates from a centralized configuration management system, and applying updates to the configuration settings of the TFTP-to-HTTPS proxy service.

In some aspect in which the TFTP-to-HTTPS proxy service is deployed in a distributed access network architecture including multiple TFTP-to-HTTPS proxy services, the methods may further include monitoring multiple UDP ports to receive TFTP requests from multiple CPE devices, and distributing TFTP communication processing among the multiple TFTP-to-HTTPS proxy services to achieve load balancing and redundancy.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIGS. 1A-1D are block diagrams illustrating alternative network implementations of some embodiments.

FIG. 2 is a message flow diagram showing sequences of messages involved in conventional TFTP communications between a CPE device modem and a TFTP server to obtain firmware downloads.

FIG. 3A a message flow diagram showing sequences of messages involved in registering a modem with an HTTPS server that can source configuration and software update files according to various embodiments.

FIG. 3B is a message flow diagram showing sequences of messages involved in communications between a CPE device modem and an HTTPS server to obtain a firmware download according to various embodiments.

FIG. 4 is a block diagram of an example TFTP-to-HTTPS proxy service computing device illustrating hardware and functional modules suitable for implementing various embodiments.

FIG. 5 is a process flow diagram illustrating a method for facilitating TFTP communications with CPE devices according to various embodiments.

FIGS. 6A-6D are process flow diagram illustrating alternative method operations for facilitating TFTP communications with CPE devices according to some embodiments.

FIG. 7 is a component diagram of an example server suitable for implementing various embodiments.

### DETAILED DESCRIPTION

The various embodiments will be described in detail with reference to the accompanying drawings. The same reference numbers will be used throughout the drawings to refer to the same or like parts wherever possible. References to particular examples and implementations are for illustrative purposes and are not intended to limit the scope of the invention or the claims.

In overview, various embodiments include methods and computing devices configured to implement the methods of delivering configuration files and firmware updates to customer premises equipment (CPE) devices using a trivial file transfer protocol (TFTP) to hypertext transfer protocol secure (HTTPS) proxy service. The TFTP-to-HTTPS proxy service is a new network element, functionality and/or module for inclusion in communication networks. In various embodiments, the TFTP-to-HTTPS proxy service is configured to perform operations of translating a TFTPS request message received from a CPE device modem into a format suitable for sending to an HTTPS server, authenticating with an HTTPS server, requesting a file download from the HTTPS server responsive to the request from the CPE device, receiving the requested file from the HTTPS server, converting the received file into a format suitable for sending to the CPE device (i.e., a format responsive to the modem request), and sending the converted file to the CPE device. Various embodiments improve the way configuration files and firmware updates are delivered to CPE devices by translating TFTP requests into HTTPS queries for transmission to servers sourcing configuration, firmware updates, and other software, and translating responsive files received in HTTPS format into TFTP format for transmission to the CPE devices. This TFTP-to-HTTPS proxy service not only enhances security but may also improve performance, scalability, and reliability of the update process.

TFTP, or Trivial File Transfer Protocol, is a simple, lightweight protocol used for transferring files over a network. TFTP operates on top of the User Datagram Protocol (UDP), which may be faster than UDP (except in high-latency networks and sending large files) but less reliable than more complex file transfer protocols like File Transfer Protocol (FTP). TFTP lacks many of the features found in FTP, such as authentication, directory browsing, and encryption. Thus, TFTP is used for simple tasks where speed and ease of implementation are more critical than advanced features and security. For example, it is commonly used to transfer small files like configuration files or firmware images to network devices during initial setup or when performing updates. TFTP is especially popular in environments where devices need to be booted or updated remotely, such as in VoIP phones, routers, switches, and when using PXE (Preboot execution Environment) for network-based booting of diskless systems.

In various embodiments, the TFTP-to-HTTPS proxy service may listen on a UDP port for incoming TFTP requests from a CPE device. In instances in which a TFTP request is received from a CPE device (e.g., a request for a configuration file, a firmware update, etc.), the proxy service translates the request into an equivalent HTTPS request suitable for retrieving configuration files or firmware updates from an HTTPS server. The translated HTTPS query may then be sent to a backend server or third-party HTTPS server where such files are maintained, which can return an HTTPS response containing the requested content. Upon receipt of this HTTPS response, the TFTP-to-HTTPS proxy service may translate the HTTPS response into a TFTP response, segment the file or update data into TFTP data packets (e.g., smaller packets suitable for transmission via TFTP) as necessary, and establish a TFTP data transfer session connection with the CPE device. The TFTP-to-HTTPS proxy service then transmits the translated file to the CPE device via TFTP. The TFTP-to-HTTPS proxy service may receive acknowledgments from the CPE for each TFTP data packet and terminate the TFTP data transfer session upon successfully transmitting all TFTP data packets.

In some embodiments, the TFTP-to-HTTPS proxy service may determine whether the requested item is already cached within the memory storage of the proxy service. In instances in which the requested item is already cached within the memory storage of the proxy service, the TFTP-to-HTTPS proxy service may retrieve the stored copy of the file and send the copy back to the requesting CPE device. This saves time required for the TFTP-to-HTTPS proxy service translate the request into HTTP format, send an HTTP query to the backend server, and process a received response. Also, in response to receiving a response from the HTTP server, the TFTP-to-HTTPS proxy service may store or cache the file or files provided in the response in the HTTPS proxy service's memory storage or cache. This caching of configuration files and firmware updates enables efficient delivery of frequently requested files or updates while reducing latency and improving overall performance when a particular requested file has been previously obtained.

Thus, in such embodiments, after receiving a TFTP request from the CPE the TFTP-to-HTTPS proxy service may check a cache for the requested configuration file or firmware update, and determine whether the requested configuration file or firmware update is present in the cache. In response to determining that the requested configuration file or firmware update is present in the cache, the TFTP-to-HTTPS proxy service may transmit the cached file or firmware update to the CPE device as described above. In response to determining that the requested configuration file or firmware update is not present in the cache, the TFTP-to-HTTPS proxy service may perform the operations of sending the translated request in HTTPS format to the backend server, receiving an HTTPS response from the backend server (e.g., including the requested configuration file, firmware update, etc.), storing the received configuration file or firmware update in cache, and sending the translated received file to the CPE device in TFTP format.

To ensure secure communications, the TFTP-to-HTTPS proxy service may use any of a variety of known authentication schema configurations to authenticate itself to the backend server or third-party HTTPS server before sending an HTTPS response and/or receiving a responsive reply. Non-limiting examples of known authentication schema that may be used include username/password combinations, digital certificates, token-based systems, and two-factor authentications (2FA). Additionally, communications between the TFTP-to-HTTPS proxy service and the backend server or third-party server may be encrypted.

In situations in which CPE devices have limited storage capacity or require specific formatting requirements during updates, the TFTP-to-HTTPS proxy service may use file segmentation and reassembly techniques (e.g., chunking), allowing efficient transmission via TFTP while maintaining compatibility with CPE device constraints.

In a distributed architecture setup, multiple TFTP-to-HTTPS proxies may be used in conjunction with each other using techniques such as DNS-based routing or IP address allocation schemes that allow requests from CPE devices to be routed across different proxy instances. This approach enables load balancing, redundancy, and scalability while ensuring seamless communication between backend servers and CPE devices.

Some embodiments may include loading configuration settings (e.g., backend server URLs, caching settings, authentication schemas, etc.) into the TFTP-to-HTTPS proxy service. This enables configuring the TFTP-to-HTTPS proxy service to particular networks and CPE systems. In some embodiments, the TFTP-to-HTTPS proxy service may periodically check for configuration updates and apply updates to the configuration settings of the TFTP-to-HTTPS proxy service. In some embodiments, the configuration setting updates may include multiple HTTPS destination configurations using fully qualified domain names or IP addresses and/or varied caching settings based on path or destination configurations. This enables updating the proxy service to handle changes in the TFTP and HTTPS protocols, keeping the TFTP-to-HTTPS proxy service up to date with the latest security patches, protocol changes, and performance optimizations, as well as supporting translations of file in various formats that may be received from third party servers into DOCSIS format for sending via TFTP to CPE devices.

Efficient port utilization may be facilitated by mitigating the complexity associated with TFTP's use of random ports post-initial UDP handshake, streamlining operations and troubleshooting, and reducing the mean time to recovery (MTTR). The TFTP-to-HTTPS proxy service may maintain compatibility with existing CPE devices governed by DOCSIS specifications by using modern protocols without necessitating changes to the CPEs. Scalable caching, achieved through varied caching settings based on path or destination configurations, may allow for efficient storage and retrieval of frequently requested configuration files and firmware updates, thereby reducing the load on backend servers and accelerating the update delivery process.

In some embodiments, the TFTP-to-HTTPS proxy service may be deployed in a distributed architecture setup, working with multiple proxies that use techniques such as DNS-based routing or IP address allocation schemes to route requests from CPE devices across different proxy instances. This embodiment configuration may enable load balancing while improving redundancy and scalability, ensuring seamless communication between backend servers and CPEs.

In some embodiments, a processor of the TFTP-to-HTTPS proxy service may monitor the performance and health of the TFTP-to-HTTPS proxy service and generate alerts upon detecting anomalies or performance issues.

Some embodiments may support multiple HTTPS destination configurations using fully qualified domain names or IP addresses, enabling the proxy service to route requests efficiently and balance the load across multiple backend servers. Some embodiments may improve the reliability of the service and allow for real-time monitoring and alerts, which may be supported by monitoring the performance and health of the TFTP-to-HTTPS proxy service, detecting anomalies or performance issues in real-time, and generating alerts for timely interventions.

User-friendly configuration management may be supported by allowing backend servers to serve DOCSIS configuration files in user-friendly formats, such as JavaScript Object Notation (JSON) or YAML, which are then converted to DOCSIS binary format within the TFTP-to-HTTPS proxy service. This approach may simplify the management of configuration files and improve the ease of troubleshooting and updates. By incorporating these features, various embodiments may enhance the efficiency, security, and scalability of delivering configuration files and firmware updates to CPE devices, optimizing the performance and reliability of service provider networks and their components.

The terms “component,” “module,” “operation,” and the like are used in this application to refer to various computer-related entities tasked with specific operational functions. These may include hardware components, software programs, combinations thereof, or processes in execution. For example, a component or a module may be a software application made of multiple operations that execute on a computing device, a processor executing instructions, a thread of a program, or the device itself. Components and modules may operate individually within a single processing environment or may be distributed across multiple processing units to utilize the capabilities of multicore or parallel computing architectures. Components may execute instructions (which may be referred to as modules) stored on different types of non-transitory computer-readable media and communicate via local or remote process interactions, inter-process communications, electronic signaling, data packet transfers, and other established protocols for data exchange and function coordination.

The term “processing system” is used herein to refer to one or more processors, including multi-core processors, that are organized and configured to perform various computing functions, such as performing functions of a server. Various embodiment methods may be implemented in one or more of multiple processors within a processing system as described herein.

DOCSIS, or Data Over Cable Service Interface Specification, is a telecommunications standard used primarily for delivering high-speed data services, such as internet and file delivery, over cable television systems. DOCSIS enables the addition of high-bandwidth data transfer to an existing cable TV (CATV) system, for example, which is particularly useful for broadband internet and file sharing applications. The DOCSIS standard defines modulation, channel access methods, and security protocols to facilitate fast and secure data delivery through coaxial cable networks. DOCSIS supports multiple versions, each offering improvements in speed, efficiency, and capabilities, thereby ensuring the standard can meet evolving technological demands and enhance user experiences in data-intensive applications.

DPoE, or DOCSIS Provisioning of EPON, is a standard that extends the familiar DOCSIS provisioning model to Ethernet Passive Optical Networks (EPON), commonly used in fiber optic networks. The DPoE Configuration File Delivery refers to the process of delivering configuration files to optical network units (ONUs) over an EPON using DOCSIS-style provisioning. This process involves the use of a configuration file similar to those used in DOCSIS systems, which contains parameters and settings governing the behavior of the ONUs. The configuration file typically specifies various operational parameters such as quality of service (QOS) settings, network management policies, and IP addressing schemes. This file is delivered to the ONUs during the initialization and provisioning phase, enabling the units to configure themselves according to the network requirements. The use of a DOCSIS-like configuration file in DPoE systems allows cable operators and service providers to leverage their existing DOCSIS-based provisioning infrastructure and expertise, thereby facilitating a smoother integration of fiber optic components into their network architectures. This approach streamlines the deployment and management of hybrid networks that incorporate both coaxial and fiber optic technologies.

CPE firmware delivery involves processes of distributing and updating the firmware of CPE devices, such as modems, routers, set-top boxes, and other network devices provided to customers by telecommunication companies and internet service providers (ISPs).

UDP, or User Datagram Protocol, is a communication protocol used across the Internet for time-sensitive transmissions such as video playback or online games where dropping packets is preferable to waiting for delayed data. Unlike Transmission Control Protocol (TCP), UDP does not guarantee the delivery of packets, order of delivery, or provide error checking and correction. This makes UDP faster and more efficient for certain types of applications, particularly those that can tolerate some loss of data but require fast transmission and low latency. UDP works by sending messages, called datagrams, which are independent of each other and may arrive out of order or not at all. UDP is widely used in real-time applications where speed is crucial and occasional data loss is acceptable, such as streaming, gaming, and voice or video communications.

Typically, DOCSIS or DPoE Configuration file Delivery and some CPE firmware delivery is exclusively conducted using TFTP. TFTP, being a legacy protocol, has at least three limitations. First, TFTP suffers from throughput and latency limitations mainly causing firmware delivery to take longer. Second, TFTP uses random ports for communication once the initial UDP handshake has happened on port 69, which is harder to track from an operation/troubleshooting standpoint resulting in longer MTTR. Third, as it is difficult to change the CPEs to support more of a current protocol like HTTP it is increasingly difficult to upgrade the back office system to a more suitable protocol as has been previously done to keep supporting TFTP as long as the CPEs in circulation are using them. Current applications and systems are HTTP-centric, and HTTP applications and systems continue to evolve more rapidly than TFTP applications and systems.

Various embodiments address several technical challenges inherent in the TFTP protocol to improve the delivery of configuration files and firmware updates, thereby enhancing the performance and functioning of the computing device, service provider network, and service provider network components. For example, positioning the TFTP-to-HTTPS proxy service near the customer premises or access gear reduces latency by reducing or minimizing round-trip travel time achieving faster delivery of configuration files and firmware updates. Translating TFTP requests into HTTPS requests may improve security by allowing the use of HTTPS with authentication for broader content delivery network (CDN) applications and delivery mechanisms while maintaining controlled unencrypted communication within the proximate network. Further improvements to the performance and functioning of the service provider network and its components will be evident from the disclosures below.

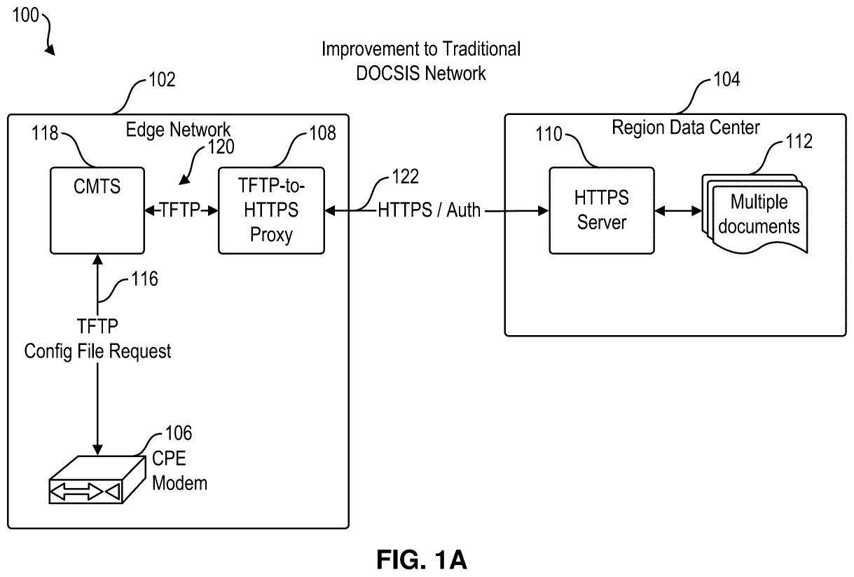

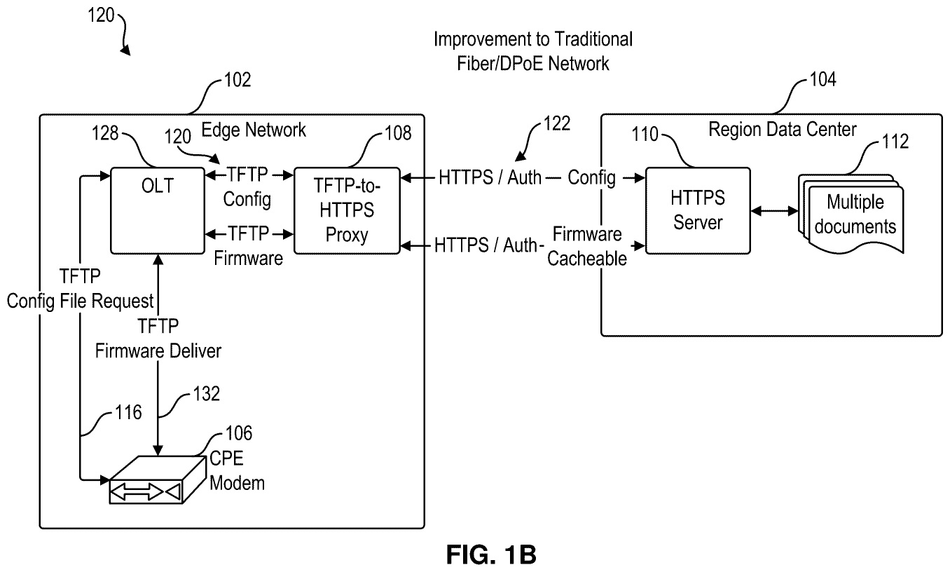

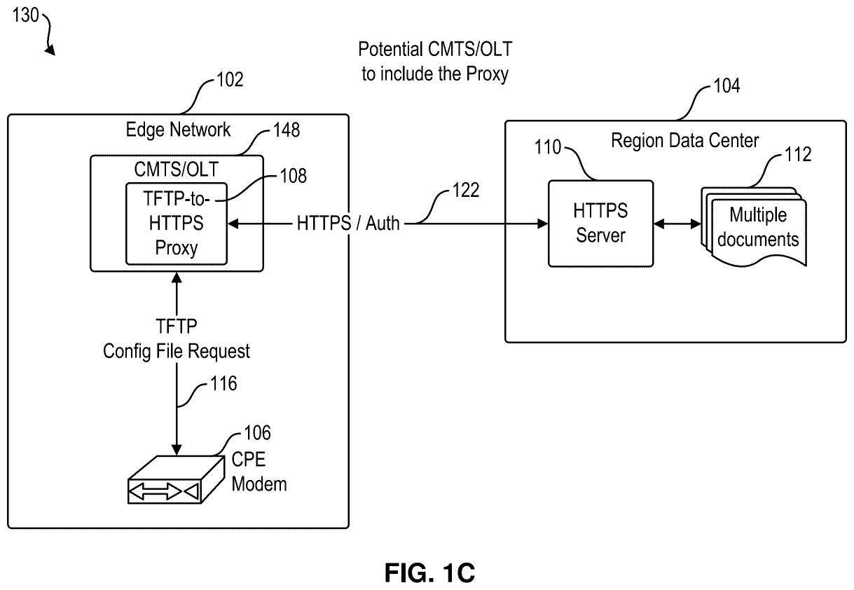

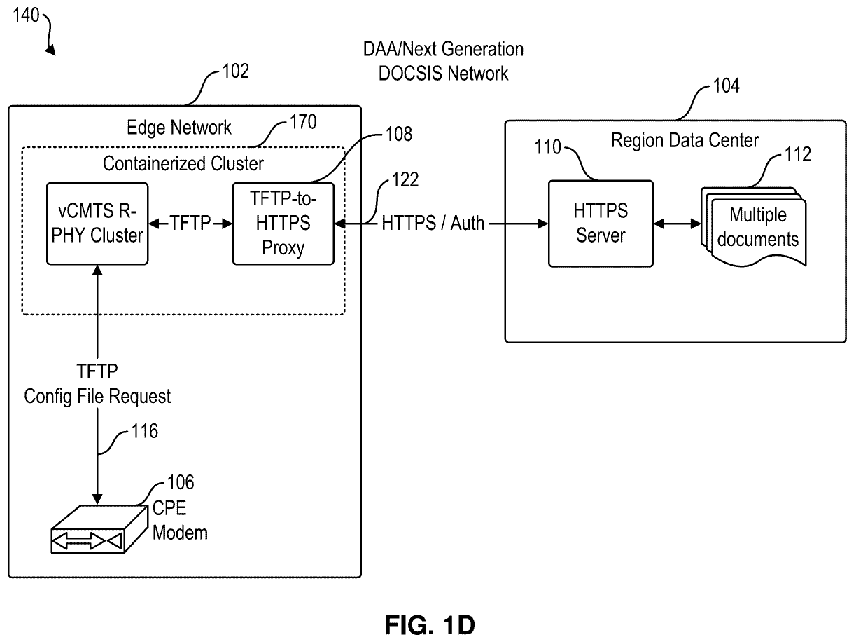

FIGS. 1A-1D illustrate four different network implementations of various embodiments defined by how and where the TFTP-to-HTTPS proxy service 108 may be implemented within an edge network 102 or network components. The four network implementations in FIGS. 1A-1D illustrate how the TFTP-to HTTPS proxy service 108 may be positioned close to the CPE, such as in the edge network 102. This may enable generating the configuration file or firmware update in the TFTP format very close to a CPE modem 106, minimizing the communication distance for the TFTP communications 116. The four illustrated network implementations are intended as examples of some ways in which various embodiments may be implemented within the scope of the claims and are not intended to limit the scope of the claims to particular network configurations.

Referring to FIG. 1A, in some network configurations 100, the TFTP-to-HTTPS proxy service 108 may be implemented as a standalone server or service software within another server or equivalent processor within the edge network 102. In this configuration, the TFTP-to-HTTPS proxy service 108 may communicate with a Cable Modem Termination System (CMTS) 118 via TFTP communications 120 within the edge network 102, and communicate with a regional data center 104 via HTTPS communications 122 with an HTTPS server 110.

A CMTS is a network element used in cable telecommunications networks to provide high-speed data services, including broadband internet and digital television over a hybrid fiber-coaxial (HFC) infrastructure. A CMTS acts as a gateway between the local cable network and the Internet, playing a pivotal role in the DOCSIS (Data Over Cable Service Interface Specification) system, which enables the delivery of Internet services over cable.

Located at the cable provider's facility, the CMTS may communicate with subscribers' cable modems located in homes and businesses. The CMTS may handle the routing, session management, and traffic shaping of data as the data flows to and from the internet and cable subscribers. The CMTS manages thousands of simultaneous data connections, providing not only Internet access but also VOIP (Voice over Internet Protocol) services and video-on-demand. This system ensures efficient allocation of bandwidth and maintains the quality of service (Qos) by managing data transmission rates, prioritizing network traffic, and ensuring that the performance needs of different types of services are met.

In the configuration 100 illustrated in FIG. 1A, the CPE modem 106 may send a configuration file request (or firmware update request) in TFTP format to the CMTS 118, which forwards the request in TFTP format 120 to the TFTP-to-HTTPS proxy service 108. The TFTP-to-HTTPS proxy service 108 translates the received request from TFTP format to HTTPS format for communicating with the regional data center 104. Before communicating the request to the regional data center, the TFTP-to-HTTPS proxy service 108 may first exchange authentication messages in HTTPS format 122 with the HTTPS server 110 to establish an authenticated, and in some implementations encrypted, communication link. Once that link is established, the TFTP-to-HTTPS proxy service 108 may send the translated file request via HTTPS 122 to the HTTPS server 110 in the regional data center 104. The HTTPS server 110 may respond to the received request, such as by accessing the requested file from a data repository 112 of multiple documents and returning the requested file in whatever data format the file was saved in 122 to the TFTP-to-HTTPS proxy service 108 via HTTPS. As described, the TFTP-to-HTTPS proxy service 108 may then translate the received file (e.g., requested configuration file or firmware update) into a format that can be used by the CPE modem 106 as well as translate messaging units (e.g., packets) from HTTPS format to TFTP format. The TFTP-to-HTTPS proxy service 108 may then provide the translated file via TFTP 120 to the CMTS 118, which passes the file to the CPE modem 106 via TFTP communications 116.

Referring to FIG. 1B, in some network configurations 120, the TFTP-to-HTTPS proxy service 108 may be implemented as a standalone server or service software within another server or equivalent processor within an edge network 102 that includes an Optical Line Terminal (OLT) 128. Similar to the configuration 100 illustrated in FIG. 1A, the TFTP-to-HTTPS proxy service 108 may communicate with the OTL 128 via TFTP communications 120 within the edge network 102, and communicate with a regional data center 104 via HTTPS communications 122 with an HTTPS server 110.

In voice communication networks, particularly those employing fiber optic technology, the OLT is an important component in a fiber-to-the-premises (FTTP) network, such as those configured as Passive Optical Networks (PON). The OLT functions as the endpoint hardware device located at the telecommunication service provider's central site. The OLT sends data from the service provider to multiple subscribers through a single optical fiber, which branches out to individual fibers connected to an Optical Network Unit (ONU) at each subscriber's premises. The OLT converts electronic digital data into optical signals, and transmits those signals over the optical distribution network. The OLT also receives optical voice signals from the network, converts them into electronic signals, and routes them to the appropriate device in the network 102, such as a CPE modem 106.

In the configuration illustrated in FIG. 1B, the CPE modem 106 may send a configuration file request 106 or firmware update request 132 in TFTP format to the OLT 128, which forwards the request in TFTP format 120 to the TFTP-to-HTTPS proxy service 108. Again, the TFTP-to-HTTPS proxy service 108 may translate the received request from TFTP format to HTTPS format for communicating with the regional data center 104, exchanges authentication messages in HTTPS format 122 with the HTTPS server 110 to establish an authenticated, and potentially encrypted, communication link, and then sends the translated file request via HTTPS 122 to the HTTPS server 110 in the regional data center 104. The TFTP-to-HTTPS proxy service 108 then receives a response including the requested file (e.g., requested configuration file or firmware update) in whatever data format the file was saved in from the HTTPS server 110 via HTTPS and translates the received file into a file format readable by the CPE modem 106 as well as translate from HTTPS format to TFTP format. The TFTP-to-HTTPS proxy service 108 may then provide the translated file via TFTP 120 to the OLT 128, which passes the file to the CPE modem 106 via TFTP communications 116, 132.

Referring to FIG. 1C, in some network configurations 130, the TFTP-to-HTTPS proxy service 108 may be implemented as a software or service module within a CMTS and/or OLT 148. Thus, rather than adding a separate server or equivalent computing device to the edge network, the TFTP-to-HTTPS proxy service 108 functionality may be included as part of the network routing component CMTS/OLTP 148, but otherwise provide similar functionality. The advantages of this implementation include that there is no additional network element, no separate TFTP communication 120 between the TFTP-to-HTTPS proxy service 108 and the CMTS or OLT 148, and requests received from the CPE modem 106 via TFTP 116 may be translated and sent via HTTPS 122, and files received via HTTPS 122 may be translated and sent to the CPE modem 106 by the integrated TFTP-to-HTTPS proxy service 108/CMTS/OLT 148.

Referring to FIG. 1D, in some network configurations 140, the TFTP-to-HTTPS proxy service 108 may be implemented as a software module or functionality within a containerized cluster 170 that includes a virtual CMTS remote physical layer (R-PHY) cluster. In an R-PHY architecture, the physical layer functions of the traditional CMTS are moved from the headend or central office to remote nodes closer to the CPE. The R-PHY cluster may include containers managing the R-PHY nodes and associated functions within the edge network, such as signal processing, network management, and communication with both the CPE devices and the centralized systems within a containerized and scalable environment. In such an implementation, the translation and communication functions of the TFTP-to-HTTPS proxy service 108 as described with reference to FIG. 1A and elsewhere herein would be performed as part of the functionality provided by the containerized cluster 170. This network configuration enables flexible implementation of various embodiments using the advantages provided by containerization, such as solutions offered by Docker, Inc. and Kubernetes® maintained by the Cloud Native Computing Foundation (CNCF).

Implementing the TFTP-to-HTTPS proxy service 108 as a software module or functionality within a containerized cluster 170 may be particularly useful in a distributed access network architecture. In such an architecture, the CMTS may be deployed within a container as a virtual CMTS (vCMTS), and one or more TFTP-to-HTTPS proxy service 108 may be implemented within a side car container positioned in the network close to the CMTS container to enable local sharing and access of config files, translation files, and communication logic without or with less need to for communicating such information across complex networks reduce redundancy. Using message techniques, such as DNS-based routing or IP address allocation schemes, requests from multiple CPE devices may be routed across multiple TFTP-to-HTTPS proxies instances. In such an architecture, multiple TFTP-to-HTTPS proxies may be deployed and configured to distribute TFTP communication transactions among the proxies to support load balancing, redundancy, and scalability while ensuring seamless communications between backend servers and CPE devices.

As noted herein, in some embodiments the TFTP-to-HTTPS proxy service 108 may store files received from the HTTPS server 110 in cache memory, either in raw or translated format, so that the next time the same file is requested, the file can be provided to a requesting CPE modem 106 from local cache memory instead of querying the regional data center. This optional capability may be included in any of the implementations illustrated in FIGS. 1A-1D.

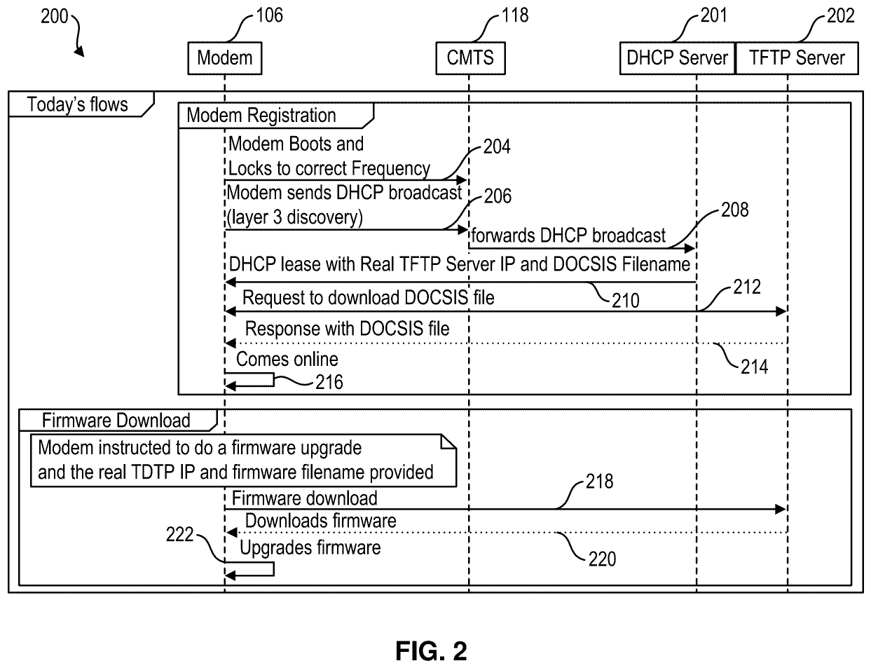

FIG. 2 is a message flow diagram 200 illustrating conventional messages exchange in a conventional network for registering a CPE device modem 106 with a TFTP server 202 for requesting and receiving firmware downloads.

In instances in which a CPE modem 106 connects to a network CMTS 118 via communications 204, it sends a broadcast message as a layer 3 discovery to the CMTS in communication 206, which forwards the broadcast to a Dynamic Host Configuration Protocol (DHCP) server 201 in communication 208. A DHCP Server is a network server that automatically assigns IP addresses and other network configuration parameters to devices on a network, enabling them to communicate with other IP networks. This layer 3 discovery broadcast communications 206, 208 asks for the necessary configuration information for establishing a communication link with a TFTP server 202. The DHCP server allocates an IP address from a pool of available addresses and sends it back to the CPE modem 106 in communication 210, along with other network configuration details, such as a subnet mask, a default gateway, and DNS server addresses. This lease of an IP address is temporary, and the duration can be predefined by the network administrator.

Using the received network configuration parameters, the CPE modem 106 may request the download of the DOCSIS file from the TFTP server 202 in communication 212. In instances in which the CPE modem 106 receives the requested DOCSIS file in communication 214, the modem may use the information to come online in operations 216. Similarly, the CPE modem 106 in communication 218 may request the download of a firmware update from the TFTP server 202. When the CPE modem 106 receives the requested firmware update in communication 220, the modem may perform a firmware update in operations 222.

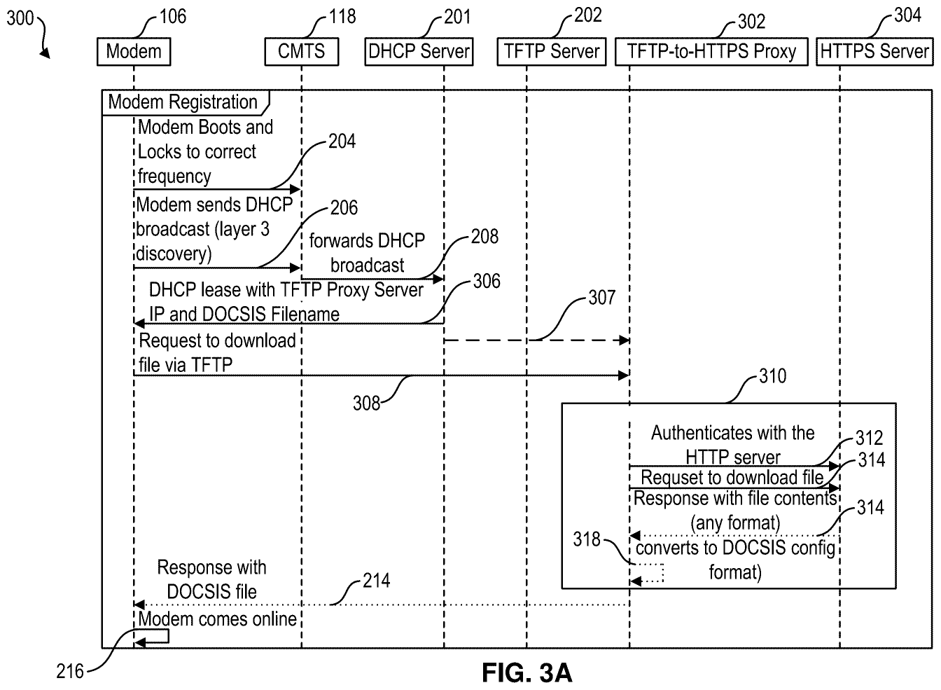

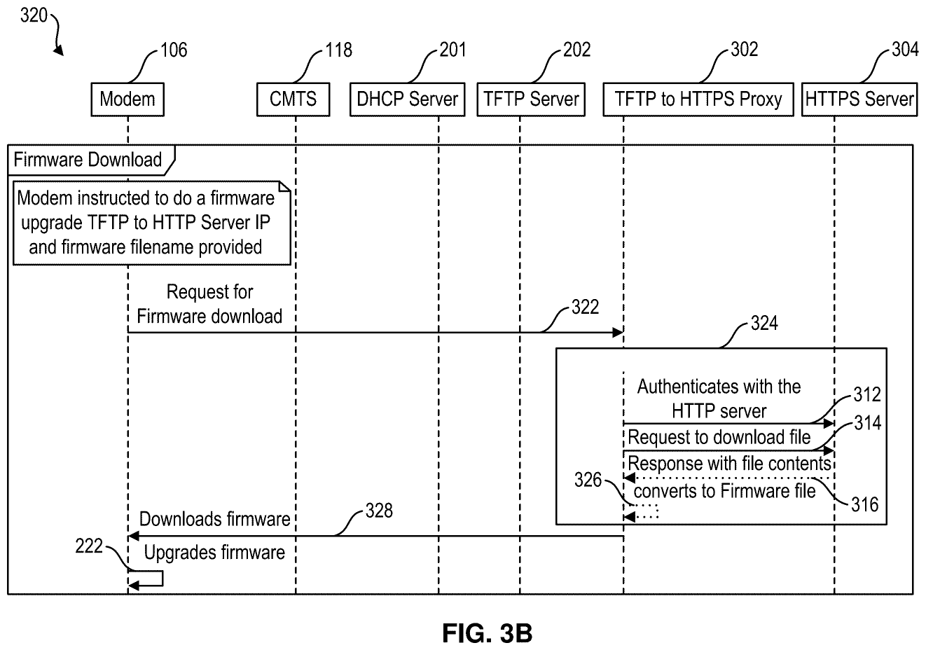

As mentioned above, various embodiments facilitate communications for obtaining firmware downloads and similar files for CPE devices via TFTP by providing a TFTP-to-HTTPS proxy service in communication paths between the modem 106 of a CPE device and an HTTPS server 110 that can provide or obtain firmware downloads and other files requested by the CPE devices. Messages associated with such communications are illustrated in FIGS. 3A and 3B.

FIG. 3A a message flow diagram 300 showing sequences of messages involved in registering a modem with an HTTPS server that can provide configuration and software update files according to various embodiments. Initially, the CPE modem 106 will boot up and lock to a current frequency with the CMTS 118 in communications 204. Once that is accomplished, the CPE modem 106 may send a DHCP broadcast (layer 3 discovery) to the CMTS 118 in communication 206, which the CMTS 118 forwards to the DHCP server 201 in communication 208. The DHCP server 201 responds to the CPE modem 106 with a DHCP lease in communication 306, which includes the TFTP-to-HTTPS proxy server's IP address and the appropriate DOCSIS filename in communication 306.

In some embodiments, when the server has determined the lease for the CPE modem 106 with the TFTP-HTTP-Proxy address in the communications 204 through 306, in optional communication 307, the DHCP server 201 may inform the TFTP-HTTP proxy service 302 that the CPE modem 106 is current in the DHCP handshake process with the relevant details of the CPE modem 106 as determined by DHCP. This enables the TFTP-HTTP-Proxy service 302 to immediately obtain the configuration from the HTTP backend server 304 and have that configuration “pre-fetched” and cached in the TFTP-HTTP-Proxy service 302 for the CPE modem before the CPE modem has even initiated a TFTP contact with the TFTP-HTTP-Proxy service. This optional communication 307 may shorten the configuration (or firmware) download process.

Using the information received in communication 306, the CPE modem 106 sends a request via TFTP to the TFTP-to-HTTPS proxy service 302 in communication 308 requesting a download of the DOCSIS file using the DOCSIS filename.

In module 310, in response to receiving the DOCSIS download request in TFTP format from the CPE modem 106, the TFTP-to-HTTPS proxy service 302 authenticates with the HTTPS server 304 in communications 312, and then requests the download of the DOCSIS file from the HTTPS server 304 in HTTPS communication 314. The HTTPS server 304 responds to the TFTP-to-HTTPS proxy service 302 in communication 314 with the file contents in any format in which the file was saved. The TFTP-to-HTTPS proxy service 302 converts the file contents to DOCSIS config format in operations 318 (if the file was saved in another format), and then sends to the DOCSIS file the CPE modem 106 in TFTP communications 214. The CPE modem 106 then processes the DOCSIS file and comes online in operation 216.

FIG. 3B is a message flow diagram 320 showing sequences of messages involved in communications between a CPE modem 106 and an HTTPS server 304 to obtain a firmware download according to various embodiments. In such operations, the CPE modem 106 may be instructed from various sources to do a file upgrade (e.g., a firmware update) in which the TFTP-to-HTTPS proxy server IP address and the firmware filename are provided. Using this information, the CPE modem 106 sends a request for the firmware download to the TFTP-to-HTTPS proxy service 302 in communication 322. In module 324, in response to this request, the TFTP-to-HTTPS proxy service 302 authenticates with the HTTPS server 304 that stores the requested file in communications 312, and then sends a request for a download of the file to the HTTPS server 304 in communication 314. The HTTPS server 304 responds to the TFTP-to-HTTPS proxy service 302 with the firmware download file contents in communication 316. In instances in which the received file is not in a downloadable firmware file format, the TFTP-to-HTTPS proxy service 302 converts the file contents to a firmware file in operations 326, and then sends the firmware file to the CPE modem 106 in communications 328. The CPE modem 106 may then perform a firmware update in operations 222 using the received firmware file.

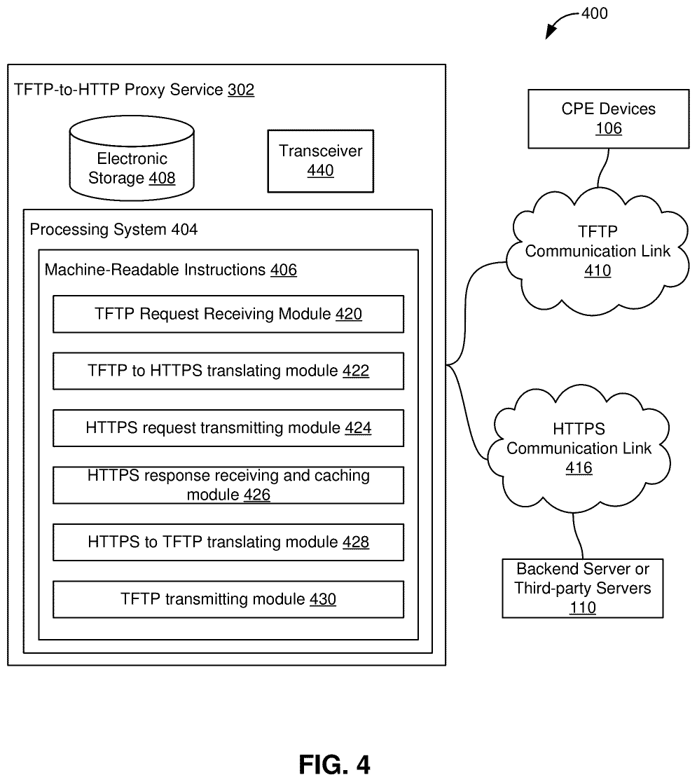

FIG. 4 is a component block diagram illustrating a system 400 providing the TFTP-to-HTTPS proxy service in accordance with various embodiments. With reference to FIGS. 1A-4, the system 400 may include a TFTP-to-HTTPS proxy service 302. The TFTP-to-HTTPS proxy service 302 may include one or more processing systems 404 coupled to electronic storage 408 and a transceiver 440. The transceiver 440 may be configured to communicate with CPE devices 106 via a TFTP communication link 410 and with backend and third-party servers 110 via HTTPS communication links 416 (e.g., local and wide area networks).

The processing system(s) 404 may be configured by machine-readable instructions 406. Machine-readable instructions 406 may include one or more instruction modules. The instruction modules may include computer program modules. In some embodiments, the functions of the instruction modules may be implemented in software, firmware, hardware (e.g., circuitry), or a combination of software and hardware, which are configured to perform particular operations or functions. The instruction modules may include one or more of a TFTP request receiving module 420, a TFTP to HTTPS translating module 422, an HTTPS request transmitting module 424, an HTTPS response receiving module 426, an HTTPS to TFTP translating module 428, a TFTP transmitting module 430, and/or other instruction modules.

The TFTP request receiving module 420 may be configured to receive a TFTP request from a CPE device 106 via one or more TFTP communication links 410. The TFTP request may be for a DOCSIS configuration file at boot time and later for update files, such as a firmware download or firmware update. In some embodiments, the TFTP request receiving module 420 may be configured to receive the TFTP request from the CPE device on a UDP port of the TFTP-to-HTTPS proxy service. In some embodiments, TFTP request receiving module 420 may be configured to check whether a received TFTP request is for a file that is stored (i.e., cached) in the electronic storage 408 from a previous file retrieval operation. In instances in which the file has been cached, the TFTP request receiving module 420 may initiate transmission of the cached file to the requesting CPE device 106 via the TFTP transmitting module 430. In instances in which the file has been cached, the TFTP request receiving module 420 may initiate translation of the request by the TFTP to HTTPS translating module 422.

The TFTP to HTTPS translating module 422 may be configured to translate TFTP requests received from a CPE device into an HTTPS format suitable for sending the request to a backend server using HTTPS. For example, the TFTP-to-HTTPS translating module 422 may be configured in software and according to TFTP and HTTPS standards to extract key information regarding the requested file from received TFTP packets and generate HTTPS packets including that information, plus addressing and other packet header information necessary to send the key information regarding the requested files to the appropriate HTTPS server.

The HTTPS request transmitting module 424 may be configured to transmit file request packets via an HTTPS communication link 416 to an appropriate backend or third-party HTTPS server 110. For example, the HTTPS request transmitting module 424 may include connections to a network for sending HTTPS packets and execute functions to affect such communications. In some embodiments, the HTTPS request transmitting module 424 may be configured to establish an authenticated communication link, by authenticating itself to the HTTPS server 110 and authenticating that server before transmitting the request message via the authenticated link. In some embodiments, the HTTPS request transmitting module 424 may be configured to encrypt the request message for secure delivery to the HTTPS server 110.

In some embodiments, the HTTPS request transmitting module 424 may be configured to obtain the DHCP lease configuration for a CPE modem from the HTTP backend server and cache the information in memory of the TFTP-to-HTTPS proxy service. In some embodiments, the TFTP-to-HTTPS proxy service may be configured to perform the processes for generating DHCP leases in which the HTTPS request transmitting module 424 may identify the DHCP lease configuration for a CPE modem without first accessing the HTTP backend server, such as prepopulating DHCP leases by prefetching and caching DHCP leases in advance of a TFTP request from the CPE modem.

The HTTPS response receiving module 426 may be configured to receive responses to requests for files from HTTPS servers, such as a backend or third party HTTPS server 110, via the HTTPS communication link 416. For example, the HTTPS response receiving module 426 may be configured to confirm when a file is received from the backend/third party server 110 that it is in response to a previously sent request and that the response includes the requested configuration file or firmware update. In some embodiments, the HTTPS response receiving module 426 may be configured to respond to authentication requests from the HTTPS server 110 as part of receiving a response. In some embodiments, the HTTPS response receiving module 426 may be configured to decrypt received responses that are sent in an encrypted format.

The HTTPS to TFTP translating module 428 may be configured to translate the HTTPS response into a TFTP response suitable for sending to the CPE device 106. For example, the HTTPS to TFTP translating module 428 may extract file information from received HTTPS packets and form the information into TFTP packets suitable for transmission according to TFTP. In some embodiments, the HTTPS to TFTP translating module 428 may be configured to also translate files of various formats, such JSON or YAML, into DOCSIS binary format or a firmware download binary file that can be received and processed by the CPE device 106.

The TFTP transmitting module 430 may be configured to send the translated TFTP data packets to the CPE device 106 via a TFTP communication link 410. In some embodiments, the TFTP transmitting module 430 may be configured to segment the information received in the HTTPS response into TFTP data packets with sizes appropriate for reliable delivery to the CPE device 106 via the TFTP communication link 410. In some embodiments, the TFTP transmitting module 430 may be configured to establish a TFTP data transfer session with the CPE device 106 prior to transmitting the translated TFTP data packets. In some embodiments, the TFTP transmitting module 430 may be configured to receive packet acknowledgments from the CPE device 106 as TFTP packets are transmitted, retransmit packets if necessary, and initiate termination of the TFTP data transfer session upon successful transmission of all TFTP packets.

The electronic storage 408 may include non-transitory storage media that electronically stores information. The electronic storage media of electronic storage 408 may include one or both of system storage that is provided integrally (i.e., substantially non-removable) with the TFTP-to-HTTPS proxy service 302 and/or removable storage that is removably connectable to the TFTP-to-HTTPS proxy service 302 via, for example, a port (e.g., a universal serial bus (USB) port, a firewire port, etc.) or a drive (e.g., a disk drive, etc.). Electronic storage 408 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 408 may include one or more virtual storage resources (e.g., cloud storage, a virtual private network, and/or other virtual storage resources). Electronic storage 408 may store software algorithms, information determined by the processing system(s) 404, information received from the TFTP-to-HTTPS proxy service 302, or other information that enables the TFTP-to-HTTPS proxy service 302 to function as described herein.

In some embodiments, processing system(s) 404 may be configured to receive and store in the electronic storage 408 various configuration settings for file translations and IP addresses for HTTPS servers to support the TFTP-to-HTTPS proxy services, such as during an initial installation. In some embodiments, the processing system(s) 404 may be configured to check for configuration updates, such as from a repository of such files maintained in a centralized configuration management system, and when appropriate, retrieve updates from the repository and store the updates in the electronic storage 408, thereby updating the TFTP-to-HTTPS proxy services to reflect current protocols, file translation processes, and network addresses.

The processing system(s) 404 may be configured to provide information processing capabilities in the TFTP-to-HTTPS proxy service 302. As such, the processing system(s) 404 may include one or more of a digital processor, an analog processor, a digital circuit designed to process information, an analog circuit designed to process information, a state machine, and/or other mechanisms for electronically processing information. Although the processing system(s) 404 are illustrated as single entities, this is for illustrative purposes only. In some embodiments, the processing system(s) 404 may include a plurality of processing units and/or processor cores. The processing units may be physically located within the same device, or processing system(s) 404 may represent processing functionality of a plurality of devices operating in coordination. The processing system(s) 404 may be configured to execute modules 420-432 and/or other modules by software; hardware; firmware; some combination of software, hardware, and/or firmware; and/or other mechanisms for configuring processing capabilities on the processing system(s) 404. As used herein, the term “module” may refer to any component or set of components that perform the functionality attributed to the module. This may include one or more physical processors during execution of processor readable instructions, the processor readable instructions, circuitry, hardware, storage media, or any other components.

The description of the functionality provided by the different modules 420-432 is for illustrative purposes, and is not intended to be limiting, as any of modules 420-430 may provide more or less functionality than is described. For example, one or more of the modules 420-430 may be eliminated, and some or all of its functionality may be provided by other modules. As another example, the processing system(s) 404 may be configured to execute one or more additional modules that may perform some or all of the functionality of the modules 420-430.

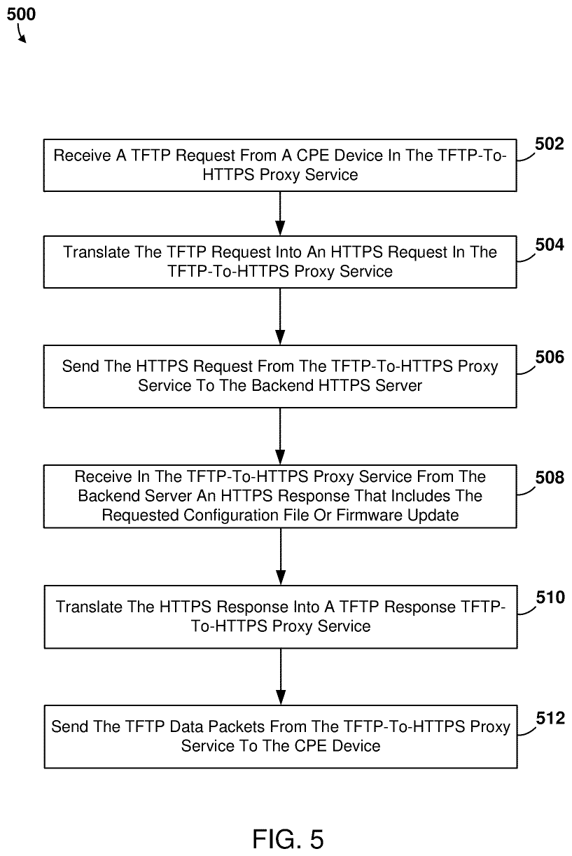

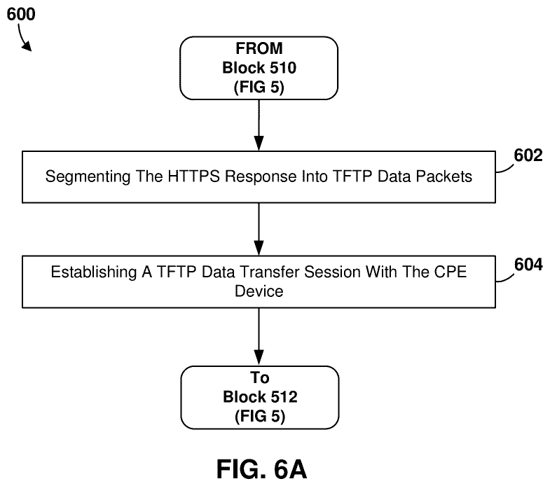

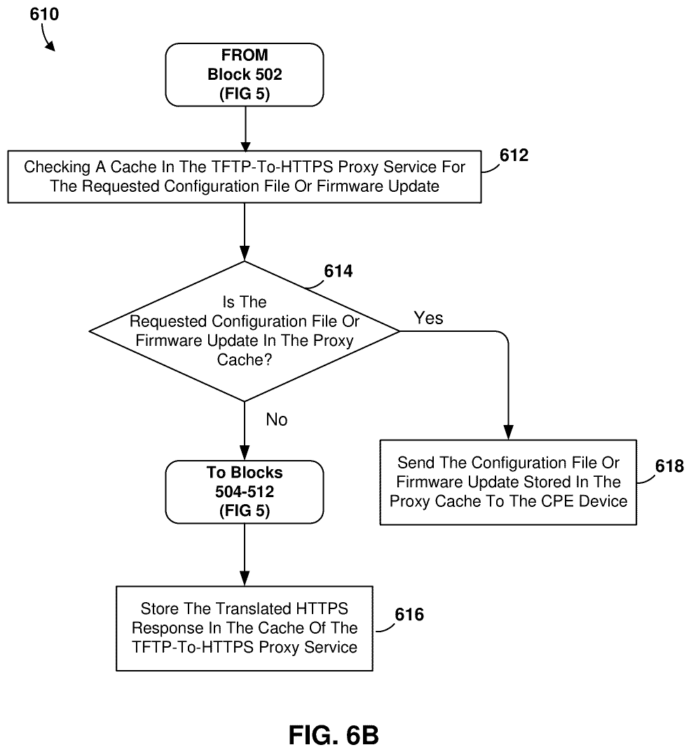

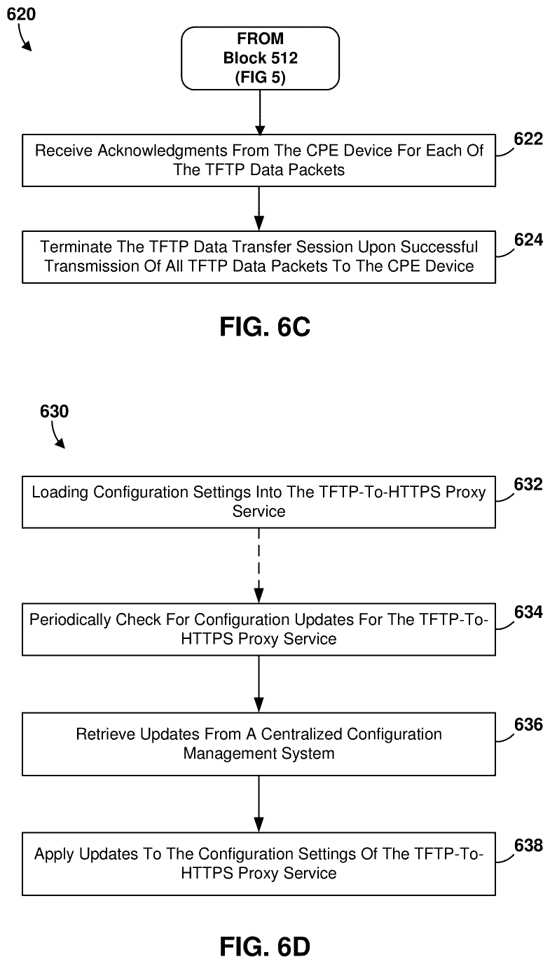

FIG. 5 is a process flow diagram illustrating a method 500 of delivering configuration files and firmware updates to CPE devices from HTTPS servers via a TFTP-to-HTTPS proxy service in accordance with some embodiments. With reference to FIGS. 1A-5, the method 500 may be performed in a computing device, such as a server, by a processing system encompassing one or more components or subsystems discussed in this application. Means for performing the functions of the operations in method 500 may include a processing system including one or more processors and other components described herein. Further, one or more processors of a processing system may be configured with software or firmware to perform some or all of the operations of method 500. To encompass the alternative configurations enabled in various embodiments, the hardware implementing any or all of the method 500 is referred to herein as a “processing system.”

In block 502, the processing system may perform operations including receiving a TFTP request from a CPE device in a TFTP-to-HTTPS proxy service. In some embodiments, the processing system may receive the TFTP request from the CPE device on a UDP port of the TFTP-to-HTTPS proxy service. For example, the processing system may initialize a UDP socket on the standard TFTP port (e.g., UDP port 69) and configure it to listen for incoming connection requests from CPE devices. The processing system may also implement error-handling mechanisms to manage network issues while receiving the TFTP request, such as packet loss or malformed requests.

To receive TFTP requests, the TFTP-to-HTTPS proxy service may be configured to listen for incoming TFTP requests from the CPE on one or more UDP sockets. For example, the processing system may initialize a UDP socket on the standard TFTP port (port by utilizing a UDP port 69) and configure it to listen for incoming connection requests from CPE devices. The processing system may also implement error-handling mechanisms to manage network issues, such as packet loss or malformed requests. In addition, the processing system may log incoming requests for monitoring and troubleshooting purposes. In some embodiments, the TFTP-to-HTTPS proxy service may be implemented as a dedicated thread or worker within the proxy service's codebase. In some embodiments, multiple TFTP-to-HTTPS proxies may be configured to listen on different UDP ports for specific CPE devices or network segments, allowing for load balancing and redundancy. The TFTP-to-HTTPS proxy service's ability to listen for incoming TFTP requests enables seamless communication with CPE devices while maintaining compatibility with DOCSIS specifications.

In some embodiments, the TFTP-to-HTTPS proxy service may be configured to prioritize incoming requests based on IP address, port number, or other criteria specified in configuration settings. Additionally, real-time monitoring and logging mechanisms may track TFTP packet traffic, including error logs for troubleshooting purposes. In some embodiments, the TFTP-to-HTTPS proxy service may be implemented as a dedicated thread or worker within the proxy service's codebase.

In some embodiments, multiple TFTP-to-HTTPS proxies may be deployed in a distributed access network architecture and configured to be responsive and ready to listen on different UDP ports for specific CPE devices or network segments. In some embodiments, the distributed access network may implement containerization technologies, including implementing a virtual CMTS in a container and implementing the TFTP-to-HTTPS proxy service in a sidecar container to enable local communications and sharing of config files and other data for supporting TFTP requests and file deliveries from/to CPE devices. As part of the operations in block 502 in such a network, multiple TFTP-to-HTTPS proxy services may monitor multiple UDP ports for and receive TFTP requests from multiple CPE devices or network segments, and allocate or distribute (e.g., using DNS-based routing or IP address allocation schemes) TFTP communication processing among the multiple TFTP-to-HTTPS proxy services to achieve load balancing and redundancy.

In block 504, the processing system may perform operations including translating the TFTP request into an equivalent HTTPS counterpart in the TFTP-to-HTTPS proxy service. For example, the processing system may process incoming UDP-based TFTP request packets from the CPE device to extract relevant information, such as the filename, version number, or type of requested file or update. The processing system may validate the request to ensure it conforms to expected formats and protocols. This may include parsing the TFTP request to identify the specific configuration file or firmware update needed by the CPE device. The processing system may also log details of the request for auditing and diagnostic purposes, facilitating accurate and efficient handling of the TFTP requests.

In the operations in block 504, the processing system may map parameters from the TFTP request to corresponding fields in an HTTPS request message. For example, the processing system may generate an HTTPS request that includes the necessary details, such as the file name, version number, and any authentication tokens. This may include converting the filename and other metadata from the TFTP format into the appropriate format for an HTTPS GET or POST request. The processing system may also append necessary headers for the HTTPS request, such as authentication tokens, content-type, and accept headers, to ensure proper communication with the backend server. The processing system may apply predefined counterparts using pre-defined translation rules stored in configuration files or databases to facilitate this conversion and ensure that the HTTPS request accurately reflects the intent of the received TFTP request. For example, the processing system may use a custom-built translation module that maps specific TFTP commands (e.g., “RRQ” and “WRQ”) to corresponding HTTPS requests.

In block 506, the processing system may perform operations including sending the HTTPS request from the TFTP-to-HTTPS proxy service to the backend HTTPS server. Prior to sending the HTTPS request, the processing system may establish a secure connection with the backend server using SSL/TLS. The HTTPS request may be routed to the appropriate back-end server URL specified in the configuration settings. The processing system may ensure secure transmission by employing SSL/TLS protocols and may handle any necessary retries or error-handling mechanisms if the initial request fails.

In block 508, the processing system may perform operations including receiving, in the TFTP-to-HTTPS proxy service from the backend server, an HTTPS response that includes the requested configuration file or firmware update. Before receiving the HTTP/HTTPS request, the TFTP-to-HTTPS proxy service may respond to requests from the backend server to authenticate itself and negotiate a secure link to ensure secure communications of the requested file or files. The TFTP-to-HTTPS proxy service may support multiple authentication schemas, such as username/password combinations, digital certificates, token-based systems, or two-factor authentications (2FA) to ensure secure communication with backend servers. Also as part of the operations in block 508, the processing system may verify the integrity and authenticity of the received data.

In block 510, the processing system may perform operations including translating the HTTPS response into a TFTP response in the TFTP-to-HTTPS proxy service. As part of translating the response, the processing system may parse the response to extract the configuration file or firmware update and prepare the file for translation. In some embodiments, the processing system may use a custom-built translation module that maps specific HTTPS requests into corresponding TFTP commands (e.g., “RRQ” and “WRQ”).

In some embodiments, as part of the operations in block 510, the processing system may translate files received in the HTTPS response from a variety of file formats, such as JSON or YAML, into DOCSIS configuration files or binary firmware download files. Such translations may be made by the processing system using translation libraries with parsing capabilities, which may be stored in memory within the TFTP-to-HTTPS proxy service.

In block 512, the processing system may perform operations including sending the TFTP data packets from the TFTP-to-HTTPS proxy service to the CPE device. For example, the processing system may transmit segmented TFTP data packets sequentially to the CPE, ensuring each packet is acknowledged before sending the next one. The processing system may handle retransmissions in case of packet loss or errors, logging each transmission attempt and acknowledgment to ensure data integrity and reliable delivery. This transmission approach may help to ensure that the CPE receives the complete configuration file or firmware update without data corruption or loss.

FIGS. 6A to 6D are process flow diagrams illustrating additional operations 600, 610, 620, 630 that may be included in or performed as part of the method 500 described with reference to FIG. 5. With reference to FIGS. 1A-6D, the additional operations 600, 610, 620, 630 may be performed in a computing device, such as a server, by a processing system encompassing one or more components or subsystems discussed in this application. Means for performing the functions of the operations in the additional operations 600, 610, 620, 630 may include a processing system including one or more processors and other components described herein. Further, one or more processors of a processing system may be configured with software or firmware to perform some or all of the additional operations 600, 610, 620, 630. To encompass the alternative configurations enabled in various embodiments, the hardware implementing any or all of the additional operations 600, 610, 620, 630 is referred to herein as a “processing system.”

Referring to FIG. 6A, in some embodiments, after translating the received file into TFTP format in block 510, the TFTP-to-HTTPS proxy service processing system may segment the HTTPS response into TFTP data packets in block 602. For example, the processing system may divide the HTTPS response data into appropriately sized chunks, format each chunk according to TFTP packet specifications, and assign sequence numbers to ensure correct reassembly by the CPE. The processing system may segment large files into smaller packets, typically ranging from 4 KB to 16 KB (configurable) for CPE devices with limited storage capacity or specific formatting requirements. This segmentation may allow for efficient and orderly data transfer over the TFTP protocol, ensuring that the CPE device receives the complete configuration file or firmware update in manageable packets.

In block 604, the processing system may establish a TFTP data transfer session with the CPE. For example, the processing system may initiate a TFTP session by sending a TFTP acknowledgment packet to the CPE, indicating readiness to transmit the segmented data packets. The processing system may also negotiate transfer parameters, such as block size and timeout settings, to ensure optimal data transfer conditions. These operations establish a TFTP communication link between the processing system and the CPE, allowing for the orderly transmission of TFTP data packets. With the TFTP communication link established, the TFTP-to-HTTPS proxy service may send the TFTP packets to the CPE device in block 512 as described.

Referring to FIG. 6B, in some embodiments, the TFTP-to-HTTPS proxy service processing system may cache files that have been retrieved from the backend/third-party HTTPS server in memory so that the proxy service can respond to frequent requests for such files with reduced latency. In such embodiments, after receiving a file request from a CPE device in block 502, the processing system may check the cache for the requested configuration file or firmware update in block 612. For example, the processing system may search the local memory storage using the filename or other unique identifiers extracted from the TFTP request. The processing system may use caching strategies such as Least Recently Used (LRU), Most Frequently Accessed (MFA), or Randomized Caching to efficiently manage and locate cached items. The system may look up a hash table or use a key-value store to quickly determine whether the requested file or update is present in the cache.

In determination block 614, the processing system may determine whether the requested configuration file or firmware update is present in the cache. For example, the processing system may check the results of the cache lookup performed in block 612. If the cache search returns a valid result, indicating the file or update is available, the processing system may confirm its presence. Otherwise, the processing system determines that the requested file or update is not in the cache. This determination process may involve verifying the integrity and relevance of the cached item by checking its timestamp, version number, or other metadata to ensure it matches the request from the CPE.

In response to determining that the requested configuration file or firmware update is present in the cache (i.e., determination block 614=“Yes”), the processing system may retrieve the file and its metadata from the proxy cache and in block 618 send the configuration file or firmware update to the CPE device via TFTP.

In response to determining that the requested configuration file or firmware update is not present in the cache (i.e., determination block 614=“No”), the processing system may perform the operations in blocks 504-512 as described to request the file from the HTTPS and prepare a received file for delivery before transmitting the file to the CPE device.

In block 616, the processing system may cache the received configuration file or firmware update in local memory. For example, the processing system may identify a suitable location within the cache based on current caching policies, such as Least Recently Used (LRU) or Most Frequently Accessed (MFA). The processing system may then write the received configuration file or firmware update to this location, update the cache metadata to reflect the new entry, and ensure that any necessary cache eviction policies are applied to maintain optimal cache performance and storage capacity.

Referring to FIG. 6C, as part of or after sending the TFTP data packets to the CPE device in block 512, the processing system may receive acknowledgments from the CPE device for each of the TFTP data packets in block 622. As described regarding the operations in block 512, the processing system may respond to a missing acknowledgement by resending the corresponding file to increase the probability of successful transmission of the file to the CPE device. In some embodiments, the processing system may inspect packet headers or payload information using a dedicated thread for handling incoming packets to detect acknowledgment messages sent by CPE devices. In some embodiments, the processing system may use algorithms, such as pattern recognition or machine learning techniques, to analyze incoming packets for specific byte sequences indicative of acknowledgment messages.

In block 624, the processing system may terminate the TFTP data transfer session in response to determining that all TFTP data packets have been successfully transmitted to the CPE device.

Referring to FIG. 6D, in block 632, the processing system may initialize the TFTP-to-HTTPS proxy service by receiving configuration settings, including backend server URLs, caching settings, and authentication schemas. For example, the processing system may access a configuration file stored in local or remote storage, read the necessary parameters, and initialize the proxy service with these settings. As part of these operations, the processing system may establish secure connections with backend servers, define cache storage locations and sizes, and set up authentication mechanisms to ensure secure communication between the proxy service and backend servers. As part of initializing the TFTP-to-HTTPS proxy service, configuration settings may be set to enable deployment in a distributed architecture with multiple proxies, such as using DNS-based routing or IP address allocation schemes to route requests from CPE devices across different proxy instantiations. The processing system may also verify the integrity and validity of the configuration settings to prevent any misconfigurations that could disrupt the proxy service operations. Once the settings are loaded, the proxy service may be prepared to listen for incoming TFTP requests, receive TFTP requests from CPE devices, and translate them into HTTP/HTTPS requests as described.

In block 634, the processing system may periodically check for configuration updates for the TFTP-to-HTTPS proxy service. For example, the processing system may query a centralized or standard configuration management system or database for any updates to configurations, translation tables, communication protocols, etc. Such checks may be performed periodically, such as according to a predefined schedule, or episodically in response to one or more predefined events.

In block 636, the processing system may retrieve updates from the centralized or standard configuration management system or database when such are available. Standard file access and download protocols may be used for such operations.

In block 638, the processing system may apply the updates to configurations settings of the TFTP-to-HTTPS proxy service. For example, the processing system may save the retrieved update files in memory replacing or supplementing configuration and similar files used by the TFTP-to-HTTPS proxy service in operation.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the other methods, and vice versa.

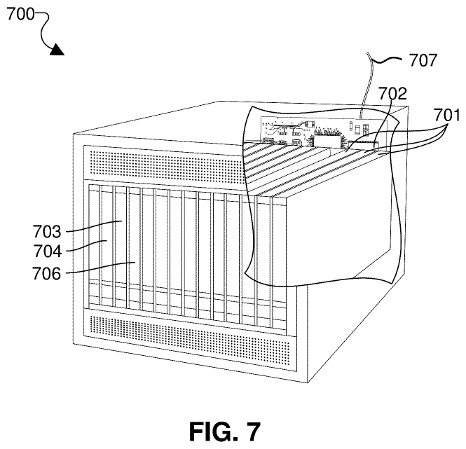

Various embodiments (including, but not limited to, embodiments discussed above with reference to FIGS. 1A-6D) may be implemented on any of a variety of commercially available computing devices, such as the server computing device 700 illustrated in FIG. 7. Such a server device 700 may include a processor 701 coupled to volatile memory 702 and a large capacity nonvolatile memory, such as a disk drive 703. The server device 700 may also include a floppy disc drive 704, USB, compact disc (CD) or DVD disc drive coupled to the processor 701. The server device 700 may also include network access ports 707 coupled to the processor 701 for establishing data connections with a network connection circuit 706 and a communication network (e.g., IP network) coupled to other communication system network elements.

Example 1. A method for delivering configuration files and firmware updates to a Customer Premises Equipment (CPE) device from a Hypertext Transfer Protocol Secure (HTTPS) service on a backend server, the method including: receiving a Trivial File Transfer Protocol (TFTP) request from the CPE device in a TFTP-to-HTTPS proxy service, the TFTP request including a request for a configuration file or a firmware update; translating the TFTP request into an HTTPS request in the TFTP-to-HTTPS proxy service; sending the HTTPS request from the TFTP-to-HTTPS proxy service to the backend server; receiving in the TFTP-to-HTTPS proxy service from the backend server an HTTPS response that includes the requested configuration file or firmware update; translating the HTTPS response into a TFTP response TFTP-to-HTTPS proxy service; and sending TFTP data packets from the TFTP-to-HTTPS proxy service to the CPE device.

Example 2. The method of example 1, further including segmenting the HTTPS response into TFTP data packets and establishing a TFTP data transfer session with the CPE device before sending the TFTP data packets from the TFTP-to-HTTPS proxy service to the CPE device.

Example 3. The method of either of examples 1 or 2, in which receiving the TFTP request from the CPE device includes receiving the TFTP request on a User Datagram Protocol (UDP) port of the TFTP-to-HTTPS proxy service.

Example 4. The method of any of examples 1-3, further including: checking a cache in the TFTP-to-HTTPS proxy service for the requested configuration file or firmware update; determining whether the requested configuration file or firmware update is present in the cache of the TFTP-to-HTTPS proxy service, in which in response to determining that the requested configuration file or firmware update is not present in the cache of the TFTP-to-HTTPS proxy service the TFTP-to-HTTPS proxy service performs operations including sending the HTTPS request to the backend server, receiving the HTTPS response from the backend server, translating the HTTPS response into a TFTP response, and sending the translated TFTP response to the CPE device, and the method further includes storing the translated HTTPS response in the cache of the TFTP-to-HTTPS proxy service, and in which in response to determining that the requested configuration file or firmware update is present in the cache of the TFTP-to-HTTPS proxy service, the method further includes sending the stored translated HTTPS response from the cache of the TFTP-to-HTTPS proxy service to the CPE device.

Example 5. The method of any of examples 1-4, further including the TFTP-to-HTTPS proxy service: receiving acknowledgments from the CPE device for each of the TFTP data packets; and terminating the TFTP data transfer session upon successful transmission of all TFTP data packets to the CPE device.

Example 6. The method of any of examples 1-5, further including loading configuration settings into the TFTP-to-HTTPS proxy service, the configuration settings including one or more of backend server universal resource locators (URLs), caching settings, or authentication schemas.

Example 7. The method of example 6, further including the TFTP-to-HTTPS proxy service: periodically checking for configuration updates for the TFTP-to-HTTPS proxy service; retrieving updates from a centralized configuration management system; and applying updates to the configuration settings of the TFTP-to-HTTPS proxy service.

Example 8. The method of any of examples 1-7, in which the TFTP-to-HTTPS proxy service is deployed in a distributed access network architecture including multiple TFTP-to-HTTPS proxy services, the method further including: monitoring multiple UDP ports to receive TFTP requests from multiple CPE devices; and distributing TFTP communication processing among the multiple TFTP-to-HTTPS proxy services to achieve load balancing and redundancy.

The processors discussed in this application may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processors themselves. Additionally, as used herein, any reference to a memory may be a reference to a memory storage and the terms may be used interchangeable.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for delivering configuration files and firmware updates to a Customer Premises Equipment (CPE) device from a Hypertext Transfer Protocol Secure (HTTPS) service on a backend server, the method comprising:
receiving a Trivial File Transfer Protocol (TFTP) request from the CPE device in a TFTP-to-HTTPS proxy service, the TFTP request comprising a request for a configuration file or a firmware update;
translating the TFTP request into an HTTPS request in the TFTP-to-HTTPS proxy service;
sending the HTTPS request from the TFTP-to-HTTPS proxy service to the backend server;
receiving in the TFTP-to-HTTPS proxy service from the backend server an HTTPS response that includes the requested configuration file or firmware update;
translating the HTTPS response into a TFTP response in the TFTP-to-HTTPS proxy service; and
sending TFTP data packets from the TFTP-to-HTTPS proxy service to the CPE device.

2. The method of claim 1, further comprising segmenting the HTTPS response into TFTP data packets and establishing a TFTP data transfer session with the CPE device before sending the TFTP data packets from the TFTP-to-HTTPS proxy service to the CPE device.

3. The method of claim 1, wherein receiving the TFTP request from the CPE device comprises receiving the TFTP request on a User Datagram Protocol (UDP) port of the TFTP-to-HTTPS proxy service.

4. The method of claim 1, further comprising:
checking a cache in the TFTP-to-HTTPS proxy service for the requested configuration file or firmware update; and
determining whether the requested configuration file or firmware update is present in the cache of the TFTP-to-HTTPS proxy service,
wherein in response to determining that the requested configuration file or firmware update is not present in the cache of the TFTP-to-HTTPS proxy service the TFTP-to-HTTPS proxy service performs operations including sending the HTTPS request to the backend server, receiving the HTTPS response from the backend server, translating the HTTPS response into a TFTP response, and sending the translated TFTP response to the CPE device, and the method further comprises storing the translated HTTPS response in the cache of the TFTP-to-HTTPS proxy service, and
wherein in response to determining that the requested configuration file or firmware update is present in the cache of the TFTP-to-HTTPS proxy service, the method further comprises sending the stored translated HTTPS response from the cache of the TFTP-to-HTTPS proxy service to the CPE device.

5. The method of claim 1, further comprising the TFTP-to-HTTPS proxy service:
receiving acknowledgments from the CPE device for each of the TFTP data packets; and
terminating the TFTP data transfer session upon successful transmission of all TFTP data packets to the CPE device.

6. The method of claim 1, further comprising loading configuration settings into the TFTP-to-HTTPS proxy service, the configuration settings comprising one or more of backend server universal resource locators (URLs), caching settings, or authentication schemas.

7. The method of claim 6, further comprising the TFTP-to-HTTPS proxy service:
periodically checking for configuration updates for the TFTP-to-HTTPS proxy service;
retrieving updates from a centralized configuration management system; and
applying updates to the configuration settings of the TFTP-to-HTTPS proxy service.

8. The method of claim 1, wherein the TFTP-to-HTTPS proxy service is deployed in a distributed access network architecture comprising multiple TFTP-to-HTTPS proxy services, the method further comprising:
monitoring multiple UDP ports to receive TFTP requests from multiple CPE devices; and
distributing TFTP communication processing among the multiple TFTP-to-HTTPS proxy services to achieve load balancing and redundancy.

9. A computing device, comprising:
a memory;
a network interface; and
a processing system coupled to the memory and the network interface and configured with processor-executable instructions to perform operations of a Trivial File Transfer Protocol (TFTP) to Hypertext Transfer Protocol Secure (HTTPS) proxy service comprising:
receiving a Trivial File Transfer Protocol (TFTP) request from the Customer Premises Equipment (CPE) device, the TFTP request comprising a request for a configuration file or a firmware update;
translating the TFTP request into an HTTPS request;
sending the HTTPS request to the backend server;
receiving from the backend server an HTTPS response that includes the requested configuration file or firmware update;
translating the HTTPS response into a TFTP response; and
sending TFTP data packets to the CPE device.

10. The computing device of claim 9, wherein the processing system is further configured with processor-executable instructions to perform operations comprising segmenting the HTTPS response into TFTP data packets and establishing a TFTP data transfer session with the CPE device before sending the TFTP data packets to the CPE device.

11. The computing device of claim 9, wherein the processing system is further configured with processor-executable instructions to perform operations such that receiving the TFTP request from the CPE device comprises receiving the TFTP request on a User Datagram Protocol (UDP) port.

12. The computing device of claim 9, further comprising a cache coupled to the processing system, wherein the processing system is further configured with processor-executable instructions to perform operations comprising:
checking the cache for the requested configuration file or firmware update;
determining whether the requested configuration file or firmware update is present in the cache;
sending the HTTPS request to the backend server, receiving the HTTPS response from the backend server, translating the HTTPS response into a TFTP response, sending the translated TFTP response to the CPE device; and storing the translated HTTPS response in the cache in response to determining that the requested configuration file or firmware update is not present in the cache; and
sending the stored translated HTTPS response from the cache to the CPE device in response to determining that the requested configuration file or firmware update is present in the cache.

13. The computing device of claim 9, wherein the processing system is further configured with processor-executable instructions to perform operations comprising:
receiving acknowledgments from the CPE device for each of the TFTP data packets; and
terminating the TFTP data transfer session upon successful transmission of all TFTP data packets to the CPE device.

14. The computing device of claim 9, wherein the processing system is further configured with processor-executable instructions to perform operations comprising loading configuration settings, the configuration settings comprising one or more of backend server universal resource locators (URLs), caching settings, or authentication schemas.

15. The computing device of claim 14, wherein the processing system is further configured with processor-executable instructions to perform operations comprising:
periodically checking for configuration updates for the TFTP-to-HTTPS proxy service;
retrieving updates from a centralized configuration management system; and
applying updates to the configuration settings of the TFTP-to-HTTPS proxy service.

16. The computing device of claim 9, wherein the processing system is deployed in a distributed access network architecture comprising multiple processing systems configured to provide TFTP-to-HTTPS proxy services, and wherein the processing system is further configured with processor-executable instructions to perform operations comprising:
monitoring multiple UDP ports to receive TFTP requests from multiple CPE devices; and
distributing TFTP communication processing among the multiple TFTP-to-HTTPS proxy services to achieve load balancing and redundancy.

17. A non-transitory processor-readable medium configured with processor-readable instructions configured to cause a processor of a computing device to perform operations of a Trivial File Transfer Protocol (TFTP) to Hypertext Transfer Protocol Secure (HTTPS) proxy service comprising:
receiving a Trivial File Transfer Protocol (TFTP) request from the CPE device, the TFTP request comprising a request for a configuration file or a firmware update;
translating the TFTP request into an HTTPS request;
sending the HTTPS request to the backend server;
receiving from the backend server an HTTPS response that includes the requested configuration file or firmware update;
translating the HTTPS response into a TFTP response; and
sending TFTP data packets to the CPE device.

18. The non-transitory processor-readable medium of claim 17, wherein the stored processor-executable instructions are configured to cause the processor of the computing device to perform operations further comprising segmenting the HTTPS response into TFTP data packets and establishing a TFTP data transfer session with the CPE device before sending the TFTP data packets to the CPE device.

19. The non-transitory processor-readable medium of claim 17, wherein the stored processor-executable instructions are configured to cause the processor of the computing device to perform operations such that receiving the TFTP request from the CPE device comprises receiving the TFTP request on a User Datagram Protocol (UDP) port of the TFTP-to-HTTPS proxy service.

20. The non-transitory processor-readable medium of claim 17, wherein the stored processor-executable instructions are configured to cause the processor of the computing device to perform operations further comprising:
checking a cache for the requested configuration file or firmware update;
determining whether the requested configuration file or firmware update is present in the cache;
sending the HTTPS request to the backend server, receiving the HTTPS response from the backend server, translating the HTTPS response into a TFTP response, sending the translated TFTP response to the CPE device; and storing the translated HTTPS response in the cache in response to determining that the requested configuration file or firmware update is not present in the cache; and
sending the stored translated HTTPS response from the cache to the CPE device in response to determining that the requested configuration file or firmware update is present in the cache.

21. The non-transitory processor-readable medium of claim 17, wherein the stored processor-executable instructions are configured to cause the processor of the computing device to perform operations further comprising:
receiving acknowledgments from the CPE device for each of the TFTP data packets; and
terminating the TFTP data transfer session upon successful transmission of all TFTP data packets to the CPE device.

22. The non-transitory processor-readable medium of claim 17, wherein the stored processor-executable instructions are configured to cause the processor of the computing device to perform operations further comprising loading configuration settings for the TFTP-to-HTTPS proxy service, the configuration settings comprising one or more of backend server universal resource locators (URLs), caching settings, or authentication schemas.

23. The non-transitory processor-readable medium of claim 22, wherein the stored processor-executable instructions are configured to cause the processor of the computing device to perform operations further comprising:
periodically checking for configuration updates for the TFTP-to-HTTPS proxy service;
retrieving updates from a centralized configuration management system; and
applying updates to the configuration settings of the TFTP-to-HTTPS proxy service.

24. The non-transitory processor-readable medium of claim 17, wherein the computing device is deployed in a distributed access network architecture comprising multiple TFTP-to-HTTPS proxy services, and wherein the stored processor-executable instructions are configured to cause the processor of the computing device to perform operations further comprising:
monitoring multiple UDP ports to receive TFTP requests from multiple CPE devices; and
distributing TFTP communication processing among the multiple TFTP-to-HTTPS proxy services to achieve load balancing and redundancy.

25. A processing system, comprising:
means for receiving a Trivial File Transfer Protocol (TFTP) request from the Customer Premises Equipment (CPE) device, the TFTP request comprising a request for a configuration file or a firmware update;
means for translating the TFTP request into a Hypertext Transfer Protocol Secure (HTTPS) request;
means for sending the HTTPS request to the backend server;
means for receiving from the backend server an HTTPS response that includes the requested configuration file or firmware update;
means for translating the HTTPS response into a TFTP response; and
means for sending TFTP data packets to the CPE device.
